(19) United States
(12) Patent Application Publication
(10) Pub. No.: US 2007/0052648 A1
(43) Pub. Date: Mar. 8, 2007

(54) Temperature compensation method for bi-stable display using drive sub-pulses

(75) Inventors: Guofu Zhou, Eindhoven (NL); Mark Thomas Johnson, Eindhoven (NL); Rogier Hendrikus Magdalena Cortie, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/571,830

(22) PCT Filed: Sep. 1, 2004
(86) PCT No.: PCT/IB04/51646

§ 371 Date: Mar. 15, 2006

(30) Foreign Application Priority Data
Sep. 18, 2003 (EP) 03103437.4

(51) Int. Cl. G09G 3/36

(52) U.S. Cl. 345/94

(57) ABSTRACT

A drive circuit for a bi-stable display comprises: a driver (101, 102) which supplies drive waveforms (DWk) to the pixels (Pij) of the display during an image update period (IUk) wherein the image presented by the pixels (Pij) is updated. A temperature sensing circuit senses the temperature of the display. A controller (103) controls the driver (101, 102) to supply, during the image update period (IUk) wherein a particular optical transition of a particular one of the pixels (Pij) is required, an associated one of the drive waveforms (DWk) to the particular one of the pixels (Pij). The associated one of the drive waveforms (DWk) comprises a sequence of a particular number of pulses (SPk), wherein consecutive ones of the pulses (SPk) of the sequence are separated by a non-zero separation period of time (SPT), during which period a voltage level is supplied which substantially keeps an optical state of the particular one of the pixels (Pij) unaltered. The particular number of said pulses (SPk), and/or a duration of said pulses (SPk), and/or a duration of the separation period (SPT) of the associated one of the drive waveforms (DWk) is determined to obtain the particular optical transition at the temperature sensed.

### FIELD OF THE INVENTION

The invention relates to a drive circuit for a bi-stable display, to a method of driving a bi-stable display, and to a display apparatus comprising a bi-stable display and such a drive circuit.

### BACKGROUND OF THE INVENTION

The publication “Drive waveforms for active matrix electrophoretic displays”, by Robert Zhener, Karl Amundson, Ara Knaian, Ben Zion, Mark Johnson, Guofu Zhou, SID2003 digest pages 842-845 discloses that grey scales are obtained of an electrophoretic display by modulating the pulse width and/or amplitude of a single drive pulse in each image update period wherein the image on the matrix display is refreshed.

The modulation of both the pulse width and the pulse amplitude provides a lot of possible optical transitions of the pixels.

### SUMMARY OF THE INVENTION

It is an object of the invention to provide a drive circuit for a bi-stable display which is able to provide a lot of optical transitions of the pixels without requiring amplitude modulation.

To reach this object, a first aspect of the invention provides a drive circuit for a bi-stable display as claimed in claim 1. A second aspect of the invention provides a method of driving a bi-stable display as claimed in claim 16. A third aspect of the invention provides a display apparatus as claimed in claim 17. Advantageous embodiments are defined in the dependent claims.

The drive circuit in accordance with the first aspect of the invention comprises a driver and a controller. The driver supplies drive waveforms to the pixels during an image update period wherein the image presented by the pixels is updated or refreshed. As different pixels may have to undergo different optical transitions, the drive waveforms may differ for different pixels.

The drive waveforms for an electrophoretic display disclosed in the SID2003 publication referred to earlier consist of a single pulse of which the duration and/or the level is controlled to obtain the required optical transition during an image update period. The not yet published European patent application with application number ID613257, PHNL030524 discloses drive waveforms for an electrophoretic display which comprise during an image update period more than one pulse. The sequence of pulses during an image update period comprises successively a first shaking pulse, a reset pulse, a second shaking pulse and a drive pulse. The reset pulse has an energy sufficient to obtain one of the two extreme optical states of the electrophoretic display. The drive pulse which succeeds the reset pulse determines the final optical state of the pixel starting from the extreme optical state. This improves the accuracy of the intermediate optical states. The intermediate optical states are grey scales if the extreme optical states are white and black which, for example, is realized in an Eink (Electronic ink) display wherein black and white particles can move in microcapsules. The optional shaking pulses have an energy which is large enough to release the particles locally of the electrophoretic display but insufficient to move the particles from one of the extreme positions to the other. The shaking pulses increase the mobility of the particles in the electrophoretic display and thus improve the reaction of the particles on the succeeding pulse. The drive waveforms may comprise a single shaking pulse per image update period only. The shaking pulses, reset pulses and drive pulses all are pulse width modulated and are not amplitude modulated.

The drive circuit in accordance with the first aspect of the invention divides the single drive pulse disclosed in the SID publication referred to earlier in a sequence of a particular number of drive pulses further referred to as drive sub-pulses. Alternatively, the drive circuit in accordance with the first aspect of the invention divides the drive pulse disclosed in the not yet published patent application ID613257, PHNL030524 in a sequence of a particular number of pulses further referred to as drive sub-pulses. Consecutive ones of the drive sub-pulses of the sequence are separated by a separation period of time. If more than two drive sub-pulses are used, and thus more than one separation period is present, the duration of the separation periods may be different. Because the separation periods should separate the successive drive sub-pulses, their duration must not be zero. The level of the drive waveform during the separation periods is selected to substantially keep the optical state of the pixel unaltered. The particular number of drive sub-pulses, and/or the duration of the drive sub-pulses, and/or the duration of the separation period(s) of a drive waveform during an image update period can be adapted.

It has to be noted that the drive waveform for a particular pixel comprises a sequence of levels which depends on the optical transition to be made by the particular pixel. Usually, each of the levels lasts an integer number of frame periods. Successive levels form either the single drive pulse or one of the different drive sub-pulses.

Usually, because each pixel might have to perform an arbitrary optical transition, the pixels should be addressable separately. Therefore, for each level of the drive waveform, usually, the pixels are selected line by line and the levels are supplied in parallel to the selected line of pixels. The minimum time required to select a line of pixels is limited because it takes some time for the pixels to be charged or discharged by the level. The minimum frame time is determined by the number of lines of the display multiplied by the minimum time required to select a line of pixels. The minimum image update period is determined by the optical state transition requiring the maximum number of levels in the sequence multiplied by the frame period. The image update period may be selected to have a duration longer than the minimum image update period.

The sequence of levels is determined by the pulses of the drive waveform. For example, the sequence of levels may comprise a sequence of an integer number of equal non-zero levels which form the single drive pulse in accordance with the SID publication referred to earlier. Or the sequence of levels may start with a shaking pulse, followed by a reset pulse and a drive pulse. The shaking pulse may comprise a sequence of levels which alternately have a predetermined positive non-zero level and a zero level which each last one frame period, or shorter if the shaking pulses are supplied to groups of the pixels at the same time. The reset pulse may comprise a sequence of non-zero levels with the predetermined positive non-zero level. The drive pulse may comprise a sequence of an integer number of predetermined negative non-zero levels.

If the display is driven with pulse width modulation at a constant amplitude, and thus the levels have a fixed value and a controlled duration, an inaccuracy of the optical states occurs due to the time discrete steps with which the duration can be changed. The smallest possible change of the duration of a pulse, which is a sequence of levels, is a single frame period. Thus, if a desired optical transition requires the level to last half a frame period longer, this cannot be realized. The actual generated duration of the level will be half a fame period too short or too long. And thus, in fact, the energy of the pulse is too large or too small for the desired optical transition.

The possibility to replace a particular single drive pulse by a series of drive sub-pulses separated by separation periods may provide a better approximation of the desired optical transition. For example, a single drive pulse with a duration of a particular number of frame periods has a particular energy which depends on the level of the drive pulse and its duration. This particular energy will cause a particular change of the optical state of the pixel receiving this drive pulse. It is assumed that this single drive pulse is sub-divided into two drive sub-pulses which together have the same duration as the single drive pulse but which are separated in time by a separation period. Although the two drive sub-pulses have together the same energy as the single drive pulse, the optical transition caused is less than the one reached with the single drive pulse. This is due to the inertness of the particles. Once the particles are moving in a particular direction they will increase their speed if the voltage across the pixel is kept constant. Thus, the amount of change of the optical state increases more than linear with the duration a continuous (single) drive pulse is applied. If the drive pulse is sub-divided, the particles will slow down during the separation period and thus the total change of the optical state reached by the two sub-divided drive pulses is less than reached with the single drive pulse although the combined duration of the sub-divided drive pulses is the same as the duration of the single drive pulse. The duration of each of the sub-divided drive pulses is also an integer times the duration of the frame period.

By sub-dividing the single drive pulse in the drive sub-pulses separated by separation periods it is possible to better approximate an optical transition which is in-between the optical transitions reachable by the single drive pulse. The number of drive sub-pulses, their duration and the duration of the separation periods can be influenced to optimally approximate the desired optical transition. The effect of these parameters of the drive sub-pulses can be determined on beforehand and the parameters required to obtain the desired optical transitions can be stored in a memory. During operation, these stored parameters are retrieved to construct drive waveforms which provide the optical transitions indicated by an input image signal.

This flexibility of sub-dividing single drive pulses is especially relevant to obtain optical transitions which are in-between optical transitions possible with the single drive pulses lasting an integer number of frame periods. Further, it is possible to intentionally increase the frame period duration to decrease the power consumption while the sub-divided drive pulses still allow providing the optical transitions of the shorter frame periods sufficiently accurately.

In an embodiment in accordance with the invention as claimed in claim 2, the drive circuit further comprises a temperature sensing circuit which senses the temperature of the display. In a drive waveform during an image update period, the particular number of drive sub-pulses, and/or the duration of the drive sub-pulses, and/or the duration of the separation period(s) is controlled in response to the sensed temperature to obtain an accurate reproduction of an optical transition at different temperatures. Thus, for example, it is assumed that the temperature of the display changes such that the desired optical transition requires the single drive pulse to last half a frame period longer. In accordance with the prior art, the resulting duration of the level will be half a frame period too short or too long if only pulse width modulation is used. The sub-divided drive pulse in accordance with this embodiment of the invention is able to decrease the dependency of the optical transitions on the temperature of the display.

In an embodiment in accordance with the invention as claimed in claim 3, the drive waveforms for all the possible optical transitions of the pixels during an image update period are stored in a memory. Actually, only the duration of the different pulses and separation periods, if present, may have to be stored. The drive waveforms are determined such that the desired optical state transitions are reached with an optimal accuracy. The drive waveforms comprise not sub-divided drive pulses if the optical transition required is obtainable with the single drive pulse or the sequence of different pulses (the shaking pulses, reset pulse and drive pulse). Both the single drive pulse and each one of the different pulses last an integer number of frame periods. However the shaking pulses may have a shorter duration. If the optical transition required can be approximated more accurately by sub-dividing the single drive pulse or the drive pulse of the sequence of the different pulses, the drive waveforms comprise a sub-divided drive pulse.

If the sub-divided drive pulses are used to compensate for temperature changes, the required characteristics of the sub-divided drive pulses for different temperatures may be stored. All the optimal waveforms for different temperatures and for every possible optical transition may be stored. After sensing the actual temperature of the display for every optical transition, as indicated by an input image signal, the required waveform can be directly found in the memory. It is also possible to store the optimal waveforms for the optical transitions for a few temperatures only and to interpolate the waveforms for in-between temperatures.

Alternatively, the duration of the continuous drive pulse (which refers to either the single drive pulse or the drive pulse of the sequence of different pulses) is roughly determined by scaling a standard stored drive waveform with a factor dependent on the sensed temperature. Now, the required duration of the continuous drive pulse is known. This duration may comprise a fraction of the frame period. If possible, the frame period duration may be adapted to optimally fit the required duration. Usually, the frame rate is increased when the temperature increases until the minimum duration of the frame period is reached. If the duration of the continuous drive pulse, which last an integer number of frame periods, is not sufficiently near to the required duration, the continuous drive pulse is sub-divided in drive sub-pulses. The number of drive sub-pulses required, the duration of the drive sub-pulses, and the duration of the separation period between the drive sub-pulses to obtain a particular optical state which is in-between the optical states reachable with the continuous pulse may be stored. These parameters of the drive sub-pulses may be determined on beforehand. It has to be noted that the duration of the each one of the drive sub-pulses and separation periods are an integer times the frame period.

In an embodiment in accordance with the invention as claimed in claim 4, the invention is applied on the drive waveform which comprises the single drive pulse disclosed in the SID publication referred to earlier. This known drive waveform is used if the sensed temperature is within a second temperature range, while this single drive pulse is replaced by the drive sub-pulses if the sensed temperature is within a first temperature range which is above or below the second temperature range. The number of drive sub-pulses and/or the duration of the separation periods is controlled to approximate the desired optical transition as close as possible, independent of the actual temperature of the display. Usually, within the second temperature range, the required optical state can be realized by changing the duration of the single drive pulse by changing the duration of the frame period. However at a particular temperature the minimum duration of the frame period is reached and the single drive pulse has to be sub-divided in drive sub-pulses to be able to approximate the required optical transition sufficiently accurate.

In an embodiment in accordance with the invention as claimed in claim 5, the drive waveform further comprises a shaking pulse which precedes the single drive pulse and/or the series of drive sub-pulses which replaces the single drive pulse. The shaking pulse reduces the influence of pixel image history and improves the grey scale accuracy and the image retention. Often, in Eink displays (Electronic ink displays, or electronic paper displays) wherein black and white particles are present in microcapsules, the drive pulse is referred to as the grey drive pulse. More in general, this pulse could be referred to as intermediate level drive pulse, which is abbreviated to drive pulse.

In an embodiment in accordance with the invention as claimed in claim 6, the invention is applied on a drive waveform which comprises at least the reset pulse and the single (grey) drive pulse. Depending on the temperature and the optical transition required the single drive pulse is used or this single drive pulse is replaced by a sequence of the drive sub-pulses.

In an embodiment in accordance with the invention as claimed in claim 7, the reset pulse is sub-divided into a series of reset sub-pulses to reach a better approximation of the required effect of the single non-sub-divided reset pulse which should have a duration which is not an integer times the frame period.

In an embodiment in accordance with the invention as claimed in claim 8, the invention is applied to a drive waveform which comprises at least the reset pulse and the single drive pulse or the sub-divided drive pulses. During particular ones of the image update periods this known drive waveform is used while during other image update periods, the single reset pulse is replaced by a sequence of reset sub-pulses. The image update periods during which the reset sub-pulses are used, and the number of reset sub-pulses and/or the duration of the separation periods may be determined by the sensed temperature.

In the embodiments in accordance with the invention as claimed in claims 9 or 10, a shaking pulse is present preceding the reset pulse. Such a shaking pulse improves the image quality.

In the embodiments in accordance with the invention as claimed in claim 11 or 12, a shaking pulse is present in-between the reset pulse and the drive pulse. Such a shaking pulse improves the image quality.

In an embodiment in accordance with the invention as claimed in claim 13, the level supplied to the pixels during the separation periods is selected such that the optical state of the pixels is kept substantially unaltered.

In an embodiment in accordance with the invention as claimed in claim 14, the level supplied to the pixels during the separation periods is selected equal to zero such that the optical state of the pixels of the bi-stable display is substantially kept constant.

In an embodiment in accordance with the invention as claimed in claim 15, a braking level is used during the separation period by applying during the separation period a level opposite to the level of the sub-pulse preceding the separation period. Now, in an electrophoretic display, during the separation period, the movement of the particles is decreased rapidly within a short period of time. The particles should start moving again at the next sub-pulse and thus the movement of the particles is minimal during the next sub-pulse. Such a braking level during the separation period may be relevant if the single pulse has to be sub-divided in a large number of sub-pulses which together have a duration which is maximally longer than the duration of the single pulse. However, the braking pulses should have a short duration because they influence the average value across the pixels.

These and other aspects of the invention are apparent from and will be elucidated with reference to the embodiments described hereinafter.

### BRIEF DESCRIPTION OF THE DRAWINGS

In the drawings:

FIG. 1 shows drive waveforms to elucidate the problem occurring if a drive waveform is used which comprises a single drive pulse,

FIG. 2 shows drive waveforms to elucidate the problem occurring if a drive waveform is used which comprises a sequence of a first shaking pulse, a reset pulse, a second shaking pulse, and a drive pulse,

FIG. 3 shows drive waveforms to elucidate embodiments in accordance with the invention wherein, in the drive waveform is used of FIG. 2, the single reset pulse and/or the single drive pulse is/are replaced by a sequence of sub-pulses,

FIG. 4 shows that the same change of an the optical state of a pixel can be obtained with a single pulse or a sequence of shorter pulses which together have a duration longer than a duration of the single pulse,

FIG. 5 shows the optical response of an electrophoretic pixel in response to a square voltage pulse,

FIG. 6 shows a display apparatus which comprises an active matrix bi-stable display,

FIG. 7 shows diagrammatically a cross-section of a portion of an electrophoretic display,

FIG. 8 shows diagrammatically a picture display apparatus with an equivalent circuit diagram of a portion of the electrophoretic display, and

FIG. 9 shows a flow chart of an algorithm for determining the sub-divided drive pulses in accordance with an embodiment of the invention.

### DETAILED DESCRIPTION OF THE PREFERRED EMBODIMENT

The indices i, j and k are used to indicate that of a particular item several are present or used. For example the pixel Pij indicates that any one of the pixels may be referred to, or the drive waveform DWk refers to any of the drive waveforms. On the other hand, DW1 refers to a particular one of the drive waveforms DWk. The same references used in different figures refer to the same items having the same function.

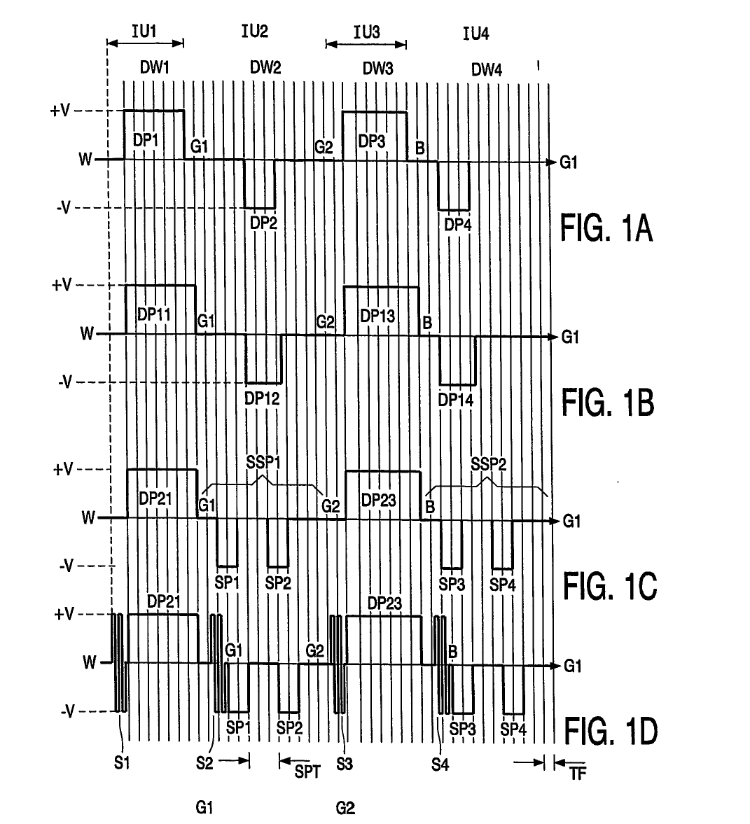

FIG. 1 shows drive waveforms to elucidate the problem occurring if a drive waveform is used which comprises a single drive pulse.

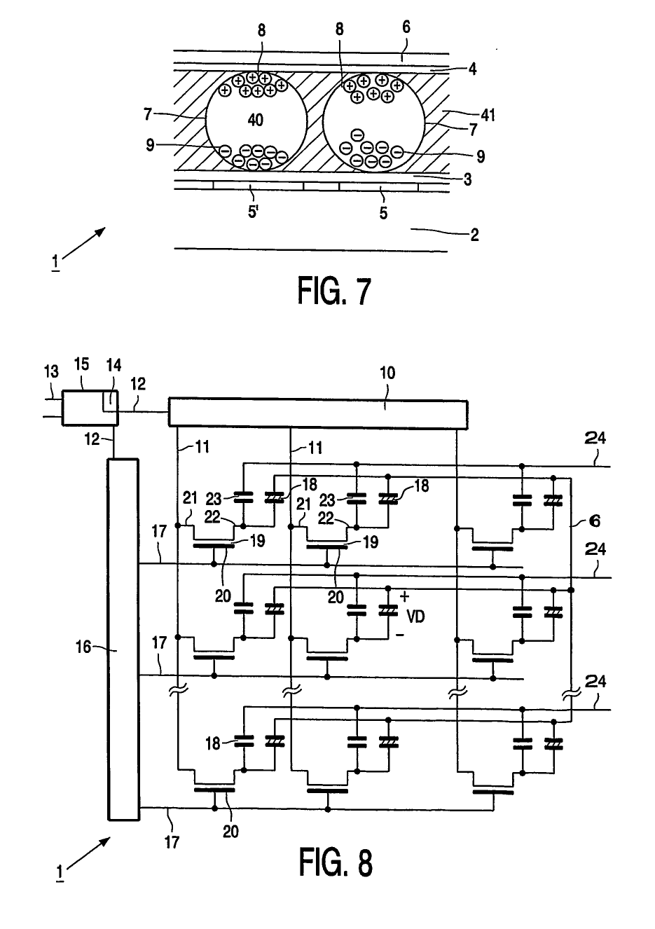

Intermediate levels in electrophoretic displays are difficult to generate reliably. In general, they are created by applying voltage pulses for specified time periods and thus are determined by the energy of the pulse applied. The intermediate levels are strongly influenced by image distortion, dwell time, temperature, humidity, lateral inhomogeneity of the electrophoretic foils etc. For example, in an Eink type electrophoretic display device which comprises micro capsules with oppositely charged white and black particles, the reflectivity is a function of the particle distribution close to the front of the capsule only, whilst the particle configuration is distributed across the entire capsule. Many configurations will show the same reflectivity. Thus, the reflectivity is not a one to one function of the configuration of the particles. Only the voltage and time response of the particles is truly deterministic, not the reflectivity at a particular instant. Consequently, the complete image history has to be considered to correctly address the electrophoretic display. A known drive method which takes care of the history is called the transition matrix based driving scheme. This method considers up to 6 prior states of a pixel and uses at least 4 frame memories to obtain a reasonable accuracy for direct grey to grey transitions. Usually such a drive method is combined with the single drive pulse disclosed in the SID publication referred to earlier and in a recently published US patent application US20030137521 (A1). If a shaking pulse is applied prior to the driving pulse, the number of frame memories can be significantly reduced while still acceptable grey scale accuracy is reached. An embodiment of an Eink type electrophoretic display is described in more detail with respect to FIGS. 7 and 8.

FIG. 1A shows a prior art drive waveform across a particular pixel Pij. The drive waveform comprises a sequence of four sub-drive waveforms DW1 to DW4 which occur during four successive image update periods IU1 to IU4, respectively. The sub-drive waveforms are also referred to as drive waveform. Each of the four drive waveforms DW1 to DW4 comprises a single drive pulse DP1 to DP4, respectively. The drive pulses DP1 to DP4 have a fixed amplitude and their duration is controlled to realize the desired optical transitions. To obtain accurate intermediate optical levels, the transition matrix based driving scheme is used. FIG. 1A shows the drive pulses DP1 to DP4 required for four consecutive optical transitions at a particular temperature of the display: first from white W to dark grey G1, then to light grey G2, then to black B, and finally to dark grey G1. It has to be noted that each of the drive pulses DP1 to DP4 lasts an integer times the frame period TF.

FIG. 1B shows the required drive waveforms to reach the same optical transitions as in FIG. 1A but at a different temperature of the display. Now, at this other (usually lower) temperature, all the drive pulses need to last longer to obtain the same optical transitions. In the example shown, the duration of the single drive pulses DP11 and DP13 is one frame period longer than the duration of the single drive pulses DP1 and DP3. A sub-division of the single drive pulses DP11 and DP13 would not provide a better approximation of the desired optical transition. The duration of the single drive pulses DP12 and DP14 should be in-between three and four frame periods TF. If it is assumed that it is not possible to decrease the duration of the frame periods TF, these durations of the drive pulses DP12 and DP14 cannot be realized and have to be rounded to either three or four frame periods TF. Consequently, the realized optical transitions will deviate from the desired optical transitions.

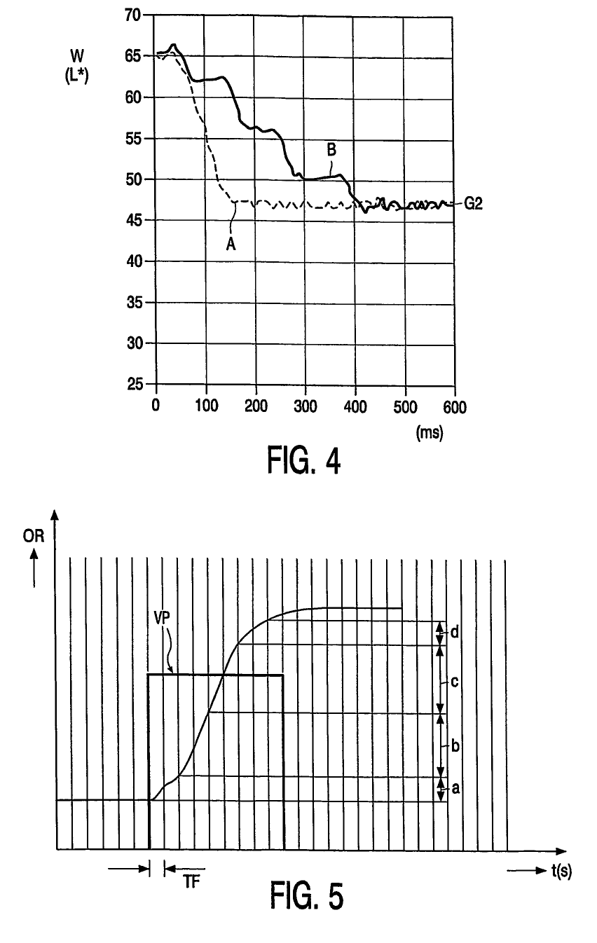

FIG. 1C shows drive waveforms wherein the single drive pulses DP12 and DP14 if FIG. 1B are sub-divided in a sequence SSP1 of drive sub-pulses SP1 to SP2 and a sequence SSP2 of drive sub-pulses SP3 to SP4, respectively. The effect of the two separated sub-pulses SP1, SP2 or SP3, SP4 on the optical transition is less than the effect would be of a single pulse with the combined duration. It is thus possible to reach an optical transition in-between the optical transitions reachable with the single pulses. This effect is elucidated in more detail with respect to FIGS. 4 and 5. This effect is not only useful to obtain optical transitions which are less temperature dependent. It can also be used to generate more intermediate optical states, or to lower the power consumption because the frame rate may be lowered while keeping the same amount of optical transitions.

FIG. 1D shows drive waveforms based on the drive waveforms shown in FIG. 1C wherein shaking pulses S1 to S4 are added preceding the drive pulses DP21; SP1, SP2; DP23; SP3, SP4, respectively.

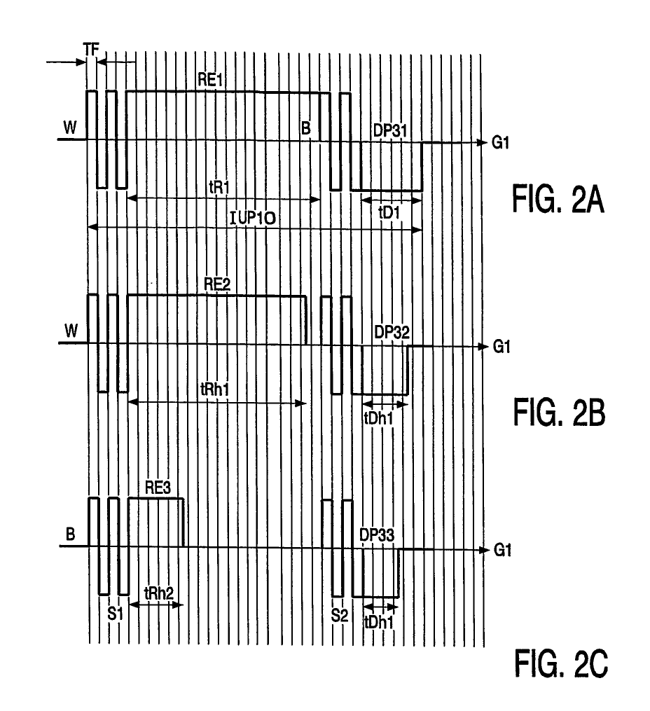

FIG. 2 shows drive waveforms to elucidate the problem occurring if a drive waveform is used which comprises a sequence of a first shaking pulse, a reset pulse, a second shaking pulse, and a drive pulse.

FIG. 2A shows a drive waveform which comprises during an image update period IUP10 successively a first shaking pulse S1, a reset pulse RE1, a second shaking pulse S2 and a drive pulse DP31. This drive waveform is required to change the optical state in an Eink type electrophoretic display with black and white particles from white to dark grey G1 at a particular temperature of the display. The reset pulse RE1 has a duration tR1 which is sufficiently long to cause the particles to move to one of the limit positions. Dependent on the polarity of the reset pulse RE1, the pixel will become white because all the white particles move towards the front of the microcapsule while the black particles move maximally away from the front, or black, dependent on the polarity of the charge of the particles. The drive pulse DP31 will change the optical state of the microcapsule from a well defined starting situation which is the limit optical state occurring when the particles are in the limit positions to the desired dark grey G1 optical state. The change of the optical state caused by the drive pulse DP31 depends on its duration tD1. This rail stabilized driving scheme improves the accuracy of the grey scales. The optional shaking pulses S1 and S2 may comprise a single pulse or a sequence of shaking sub-pulses. The shaking pulses S1 and S2 “shake” the particles to decrease their inertia and to obtain a more rapid reaction on the pulse succeeding the shaking pulse S1, S2. This improves the reproducibility of the grey scales. The duration of each of the different pulses is an integer times the frame period TF.

FIG. 2B shows the drive waveform required to obtain the same optical transition from white W to dark grey G1 but at a higher temperature than in FIG. 2A. Now, the duration tRh1 of the reset pulse RE2 should be shorter than the duration tR1 of the reset pulse RE1, and the duration tdh1 of the drive pulse DP32 should be shorter than the duration tD1 of the drive pulse DP31. By way of example, a situation is depicted wherein the duration of both the reset pulse RE2 and the drive pulse DP32 are not an integer times the frame period TF. The reset pulse RE2 has a duration tRh1 of 17.4 frame periods TF, and the drive pulse DP32 has a duration tdh1 of 4.5 frame periods TF.

FIG. 2C shows the drive waveform at the higher temperature but now for an optical transition from black B to dark grey G1. Again, the required duration tRh2 of the reset pulse RE3 and the duration tDh1 of the drive pulse DP33 is not an integer times the frame period TF. The reset pulse RE3 has a duration of 5.5 frame periods TF, and the drive pules DP33 has a duration of 3.5 frame periods TF.

Consequently, in the prior art, these drive waveforms shown in FIG. 2B and 2C cannot be realized. The duration of the reset pulses RE2 and RE3 and the drive pulses DP32 and DP33 has to be selected equal to the nearest integer times the frame period TF. This causes the optical transitions to depend on the temperature of the display.

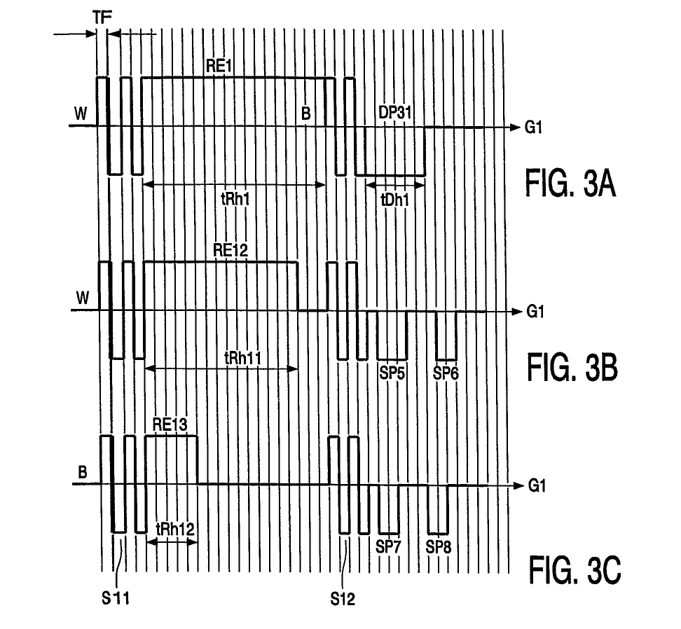

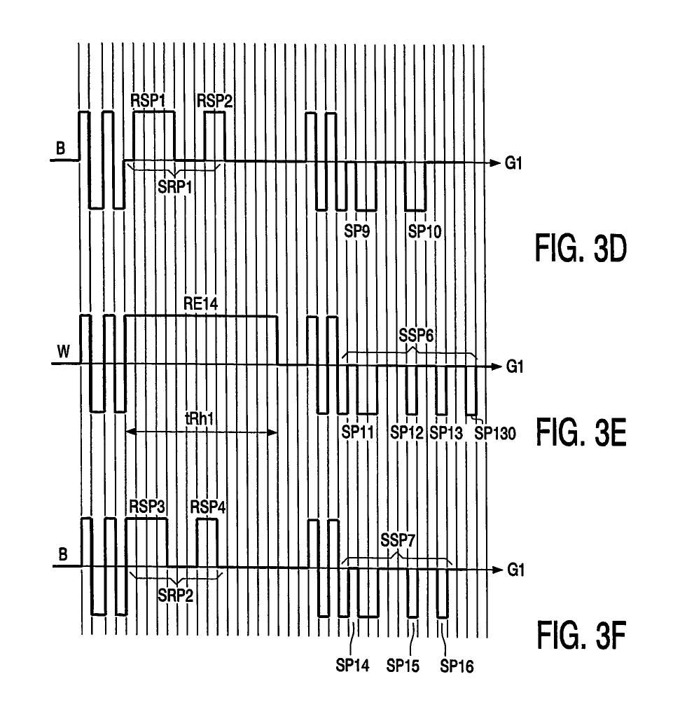

FIG. 3 shows drive waveforms to elucidate embodiments in accordance with the invention wherein the drive waveform is used of FIG. 2 wherein the single reset pulse and/or the single drive pulse is/are replaced by a sequence of sub-pulses. Again, all the drive waveforms shown comprise successively: the optional first shaking pulse S1, the optional reset pulse RE11, RE12, or RE13, the optional second shaking pulse S2 and the single drive pulse DP41, or the drive sub-pulses SP5, SP6 or SP7, SP8.

FIG. 3A shows the same drive waveform as shown in FIG. 2A, thus for the same optical transition from white W to dark grey G1 at the particular temperature.

FIG. 3B shows the drive waveform of FIG. 2B wherein the duration of the reset pulse RE2 is rounded to an integer number of frame periods TF such that the duration tRh11 of the reset pulse RE12 is nearest to the duration tRh1 of the reset pulse RE2 of FIG. 2B. Further, the drive pulse DP32 of FIG. 2B is now sub-divided into a drive sub-pulse SP5 which lasts three frame periods TF and a drive sub-pulse SP6 which lasts two frame periods TF. The separation period of time which separates the two drive sub-pulses SP5 and SP6 lasts three frame periods TF. Although the summed duration of the two drive sub-pulses SP5 and SP6 is longer than the 4.5 frame periods of the single drive pulse DP32, due to the separation period, the optical effect is very near to the desired optical effect reached by the single drive pulse DP32. Because the effect of the drive sub-pulses SP5 and SP6 on the optical transition is much higher than the effect of the reset pulse RE12, the rounding of the duration of the reset pulse RE12 to an integer number of frame periods TF is usually not noticeable. Thus is especially true if an over-reset drive scheme is implemented, wherein the duration of the reset pulse is longer than required to move the particles to the limit positions. It is also possible to correct the effect of this rounding off of the reset pulse RE12 to some degree by optimizing the drive pulse.

FIG. 3C shows the drive waveform of FIG. 2C wherein the duration of the reset pulse RE3 is rounded to an integer number of frame periods TF such that the duration tRh12 of the reset pulse RE13 is nearest to the duration tRh2 of the reset pulse RE3 of FIG. 2C. Further, the drive pulse DP33 of FIG. 2B is now sub-divided into two drive sub-pulses SP7 and SP8 which each last two frame periods TF. The separation period of time which separates the two drive sub-pulses SP7 and SP8 lasts three frame periods TF. Although the summed duration of the two drive sub-pulses SP7 and SP8 is longer than the 3.5 frame periods of the single drive pulse DP33, due to the separation period, the optical effect is very near to the desired optical effect reached by the single drive pulse DP33. Because the effect of the drive sub-pulses SP7 and SP8 on the optical transition is much higher than the effect of the reset pulse RE13, the rounding of the duration of the reset pulse RE13 to an integer number of frame periods TF is usually not noticeable. Thus is especially true if an over-reset drive scheme is implemented, wherein the duration of the reset pulse is longer than required to move the particles to the limit positions.

FIG. 3D shows the drive waveform is shown in FIG. 3C, wherein the reset pulse RE13 of FIG. 3C is sub-divided into a series of sub-pulses SRP1 which comprises two reset sub-pulses RSP1 and RSP2. The duration of the reset sub-pulse RSP1 is four frame periods TF, the duration of the reset sub-pulse RSP2 is two frame periods TF, and the duration of the separation period between the two reset sub-pulses RSP1, RSP2 is three frame periods TF. The optical effect of these two reset sub-pulses RSP1, RSP2 approximates the desired optical effect of the reset pulse RE3 better than the optical effect reached by the integer frame period TF duration of the reset pulse RE13. For the reset pulse RE3 which has a short duration, the effect of rounding to the nearest integer number of frame periods may become visible. Thus, in this example, the use of the reset sub-pulses improves the accuracy of the reproduction of the optical transition if the temperature of the display varies.

FIG. 3E shows the drive waveform of FIG. 2B wherein the single drive pulse DP32 of FIG. 2B is approximated by a sequence SSP6 of four drive sub-pulses SP11, SP12, SP13 and SP130. The drive sub-pulse SP11 lasts 2 frame periods TF, the drive sub-pulses SP12, SP13 and SP130 last one frame period TF, the separation period between the drive sub-pulses SP11 and SP12 lasts three frame periods TF, and the separation period between the drive sub-pulses SP12 and SP13, and SP13 and SP130 lasts two frame periods TF. In this example, this sequence SSP6 approximates the desired optical effect of the single drive pulse DP32 (FIG. 2B) even better than the sequence of the drive sub-pulses SP5 and SP6 (FIG. 3B).

FIG. 3F shows the drive waveform of FIG. 2C wherein the single reset pulse RE3 is sub-divided into the two reset sub-pulses RSP3 and RSP4 to form a sequence SRP2 which is identical to the sequence SRP1 shown in FIG. 3D. Thus, the drive waveform shown in FIG. 3F approximates the desired optical effect of the non-integer frame period TF duration of the reset pulse RE3 and drive pules DP33 of FIG. 2C much better than rounding off the duration of the reset pulse RE3 and the drive pulse DP33 to a nearest integer number of frame periods. Further, the drive waveform of FIG. 3F shows the same drive sub-pulses as shown in FIG. 3E but now referred to as the sequence SSP7 of drive sub-pulses SP14, SP15 and SP16.

FIG. 4 shows that the same change of the optical state of a pixel can be obtained with a single pulse or a sequence of shorter pulses which together have a duration longer than a duration of the single pulse. FIG. 4 shows representative experimental results of the optical transition caused by a drive waveform A, and of the optical transition caused by a drive waveform B. The drive waveform A comprises a single pulse with a duration of 6 frame periods TF which in this example is 120 ms. The drive waveform B comprises four drive sub-pulses, each with a duration of two frame periods TF of 40 ms. The four drive sub-pulses are separated by separation periods which all last three frame periods TF. The optical state L* as function of the time t in milliseconds is shown for an optical transition from white W to light grey G2. It is clearly shown that starting from substantially the same white W optical state a substantially the same light grey G2 optical state is achieved by both the drive waveforms A and B. However, the total energy involved in the single drive pulse is 6×V×TF while the energy in the sub-divided grey drive pulse SSP4 is 4×2×V×TF. It is thus possible to influence the average energy occurring across a pixel Pij during a sequence of image update periods IUk while the same optical transitions are obtained. Or said differently, it is possible to obtain an optical effect by the sub-divided drive pulse which cannot be reached by the single drive pulses which have a duration equal to an integer number of frame periods. Or said in still other words, by using a sequence of drive sub-pulses instead of a single drive pulse, it is possible to obtain better approximations of a particular optical transition at different temperatures of the display than would be possible with the single drive pulses.

FIG. 5 shows the optical response of an electrophoretic pixel in response to a square voltage pulse. In this example, the voltage pulse VP has a duration of 9 frame periods TF. The optical response OR in the first two frame periods TF of the pulse VP is represented by a, the response during the subsequent two frame periods TF of the pulse VP is represented by b, the optical response in the next two frame periods TF of the pulse VP is represented by c, the optical response in the last two frame periods TF of the pulse VP is represented by d. Although the time period always lasts two frame periods TF, the optical responses a, b, c, d are largely different. This is due to the fact that the optical response of the particles to the duration the external electric field applied is not linear in electrophoretic display materials. This non-linearity is used in the embodiments in accordance with the invention by sub-dividing single drive pulses into sequences of drive sub-pulses separated by separation periods in time to obtain three effects. Firstly, it can be used to provide additional optical transitions in-between the optical transitions which are possible with single drive pulses lasting an integer number of frame periods. Secondly, it can be used to decrease the frame rate while keeping the same amount of optical transitions. Thirdly, it can be used to better approximate the non-integer number of frame periods duration of the drive pulse at different temperatures. This minimizes the inaccuracy occurring in the same optical transitions at different temperatures.

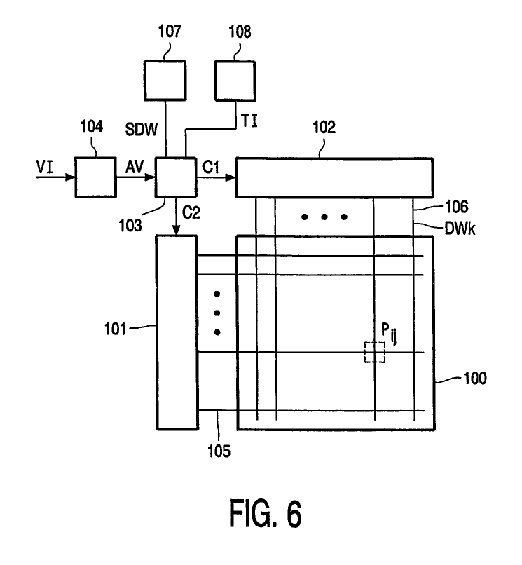

FIG. 6 shows a display apparatus which comprises an active matrix bi-stable display. The display apparatus comprises a bi-stable matrix display 100. The matrix display comprises a matrix of pixels Pij associated with intersections of select electrodes 105 and data electrodes 106. The active elements which are associated with the intersections are not shown. A select driver 101 supplies select voltages to the select electrodes 105, a data driver 102 supplies data voltages to the data electrodes 106. The select driver 101 and the data driver 102 are controlled by the controller 103 which supplies control signals C1 to the data driver 102 and control signals C2 to the select driver 101. A memory 107 stores the drive waveforms DWk required for all possible optical transitions of the pixels Pij. The controller 103 is able to retrieve these stored drive waveforms SDW from the memory 107. The temperature sensing circuit 108 senses the temperature of the display and supplies an temperature indication TI of the sensed temperature to the controller 103.

Usually, the controller 103 controls the select driver 101 to select the rows of pixels Pij one by one, and the data driver 102 to supply drive waveforms DWk via the data electrodes 106 to the selected row of pixels Pij. Without the implementation of the sub-divided pulses SPk in accordance with the embodiments of the invention, for example, the drive waveforms of FIG. 1A, FIGS. 2 or FIG. 3A are supplied to the pixels Pij. If the sub-divided pulses SPk are required to be supplied to a pixel SPij, for example, one of the drive waveforms of FIG. 1B, FIG. 1C, FIG. 3B to FIG. 3F is supplied to the pixel Pij. The drive waveforms DWk with the single pulse and with the sub-divided pulses SPk may be stored in the memory 107.

Whether for a particular optical transition sub-divided pulses are used or not, and what the characteristics of the sub-divided pulse SPk are, may be predetermined. Thus if, during a particular image update period IUk, a particular optical transition is required the pre-stored drive waveform is retrieved from a memory. This predetermined stored drive waveform comprises either an undivided pulse or the sub-divided pulses SPk, as predetermined to be best suitable for the particular optical transition at the particular temperature. The characteristics of the sub-divided pulses SPk may be the number of pulses, the duration of the pulses, the duration of the separation periods.

Thus, whether for a particular optical transition sub-divided pulses are used or not is determined by the actual temperature of the display. The control circuit 103 controls the number and/or duration of the sub-divided pulses SPk, and/or the duration of the separation periods SPT such that the same required optical transition is reached with the single pulse at a particular temperature as with the sub-divided pulses at another temperature.

FIG. 7 shows diagrammatically a cross-section of a portion of an electrophoretic display, which for example, to increase clarity, has the size of a few display elements only. The electrophoretic display comprises a base substrate 2, an electrophoretic film with an electronic ink which is present between two transparent substrates 3 and 4 which, for example, are of polyethylene. One of the substrates 3 is provided with transparent pixel electrodes 5, 5′ and the other substrate 4 with a transparent counter electrode 6. The counter electrode 6 may also be segmented. The electronic ink comprises multiple microcapsules 7 of about 10 to 50 microns. Each microcapsule 7 comprises positively charged white particles 8 and negatively charged black particles 9 suspended in a fluid 40. The dashed material 41 is a polymer binder. The layer 3 is not necessary, or could be a glue layer. When the pixel voltage VD across the pixel 18 (see FIG. 2) is supplied as a positive drive voltage Vdr (see, for example, FIG. 3) to the pixel electrodes 5, 5′ with respect to the counter electrode 6, an electric field is generated which moves the white particles 8 to the side of the microcapsule 7 directed to the counter electrode 6 and the display element will appear white to a viewer. Simultaneously, the black particles 9 move to the opposite side of the microcapsule 7 where they are hidden from the viewer. By applying a negative drive voltage Vdr between the pixel electrodes 5, 5′ and the counter electrode 6, the black particles 9 move to the side of the microcapsule 7 directed to the counter electrode 6, and the display element will appear dark to a viewer (not shown). When the electric field is removed, the particles 8,9 remain in the acquired state and the display exhibits a bi-stable character and consumes substantially no power. Electrophoretic media are known per se from e.g. U.S. Pat. No. 5,961,804, U.S. Pat. No. 6,1120,839 and U.S. Pat. No. 6,130,774 and may be obtained from EInk Corporation.

FIG. 8 shows diagrammatically a picture display apparatus with an equivalent circuit diagram of a portion of the electrophoretic display. The picture display device 1 comprises an electrophoretic film laminated on the base substrate 2 provided with active switching elements 19, a row driver 16 and a column driver 10. Preferably, the counter electrode 6 is provided on the film comprising the encapsulated electrophoretic ink, but, the counter electrode 6 could be alternatively provided on a base substrate if a display operates based on using in-plane electric fields. Usually, the active switching elements 19 are thin-film transistors TFT. The display device 1 comprises a matrix of display elements associated with intersections of row or select electrodes 17 and column or data electrodes 11. The row driver 16 consecutively selects the row electrodes 17, while the column driver 10 provides data signals in parallel to the column electrodes 11 to the pixels associated with the selected row electrode 17. Preferably, a processor 15 firstly processes incoming data 13 into the data signals to be supplied by the column electrodes 11.

The drive lines 12 carry signals which control the mutual synchronisation between the column driver 10 and the row driver 16.

The row driver 16 supplies an appropriate select pulse to the gates of the TFT's 19 which are connected to the particular row electrode 17 to obtain a low impedance main current path of the associated TFT's 19. The gates of the TFT's 19 which are connected to the other row electrodes 17 receive a voltage such that their main current paths have a high impedance. The low impedance between the source electrodes 21 and the drain electrodes of the TFT's allows the data voltages present at the column electrodes 11 to be supplied to the drain electrodes which are connected to the pixel electrodes 22 of the pixels 18. In this manner, a data signal present at the column electrode 11 is transferred to the pixel electrode 22 of the pixel or display element 18 coupled to the drain electrode of the TFT if the TFT is selected by an appropriate level on its gate. In the embodiment shown, the display device of FIG. 1 also comprises an additional capacitor 23 at the location of each display element 18. This additional capacitor 23 is connected between the pixel electrode 22 and one or more storage capacitor lines 24. Instead of TFTs, other switching elements can be used, such as diodes, MIMs, etc.

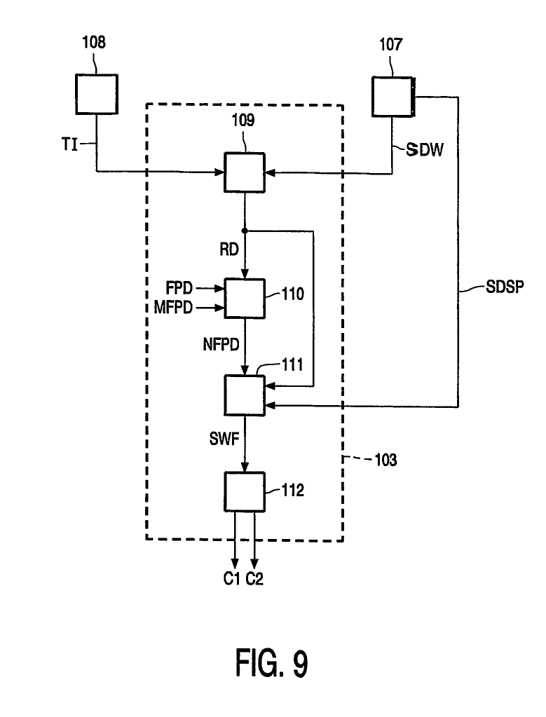

FIG. 9 shows a flow chart of an algorithm for determining the sub-divided drive pulses in accordance with an embodiment of the invention.

In step 108, the temperature TI of the display is sensed. In step 107, a stored drive waveform SDW is retrieved, for example from a non-volatile memory. The stored drive waveform SDW comprises the single and continuous drive pulse DPk. The stored drive waveform SDW may comprise other pulses, such as shaking pulses Sk and/or a reset pulse REk. In step 109, the retrieved drive waveform SDW is scaled with a factor depending on the temperature TI to obtain the required (optimal) duration of the pulse(s) RD. This required duration of the pulse(s) RD may comprise a single value indicating the duration of the drive pulse DPk if the drive waveform does not contain any other pulses. Or this required duration of the pulse(s) RD may comprise several values indicating the required optimal durations of the different pulses (shaking pulse(s) SPk, reset pulse REk, and drive pulse DPk). The required duration of the pulse(s) may last a non-integer number of frame periods TF. Usually, for electrophoretic displays, the duration of the pulse(s) RD of the drive waveform should decrease if the temperature TI increases. In the now following is discussed how the required duration RD of the drive pulse DPk is approximated as close as possible. In the same manner it may be possible to further determine the best approximation of the duration RD of the reset pulse REk, if present in the drive waveform.

In step 110, it is checked whether it is possible to decrease the actual frame period duration FPD to obtain the required duration RD of the drive pulse DPk without decreasing the actual frame period duration FPD below the minimum frame period duration MPFD. If this is not possible, still the actual frame period duration FPD may be decreased to obtain a new frame period duration NFPD at which the best possible approximation of the required duration of the drive pulse DPk is obtained. To be able to check whether a better approximation of the required duration RD of the drive pulse DPk is possible by changing the duration of the frame period TF, the step 110 receives the required duration RD of the drive pulse DPk. Alternatively, the step 10 may receive the stored drive waveform SDW and the scaling factor.

In step 111 it is checked whether the required duration RD of the drive pulse DPk of the drive waveform realized with the new frame period duration NFPD can be better approximated by a subdivided drive pulse (also referred to as a sequence SSPk of drive sub-pulses SPi) SSPk. The sequence of drive sub-pulses SSPk may also be stored in the memory as stored drive sub-pulses SDSP, and are retrieved by step 111 from the memory. Thus, in step 111 the most suitable drive waveform is determined to obtain the best approximation of the effect of the duration of the single drive pulse DPk which has the required duration RD which is not an integer number of the present frame periods FPD which may be the decreased new frame period duration NFPD. This best approximation may be obtained by sub-dividing the prior art single drive pulse DPk into a sequence of drive sub-pulses SSPk, wherein the drive sub-pulses SPi are divided by separation periods. The number of drive sub-pulses SPi, and/or their duration, and/or the duration of the separation periods is or are selected to obtain this best approximation. For example, the step 111 may comprise a look-up table in which for a number of durations of the single drive pulse DPk the information SWF about the best possible sub-division into drive sub-pulses SPi can be retrieved. The information SWF may contain the duration of each of the drive sub-pulses SPi and the duration of each of the separation periods between the drive sub-pulses SPi. Alternatively, the information SWF may only contain the number of drive sub-pulses SPi if the duration of the drive sub-pulses SPi and the duration of the separation periods is fixed. The information in the look-up table can be determined experimentally by measuring the light output after an optical transition for a lot of possible subdivisions of the single drive pulse DPk.

In step 112, the information SWF on the best possible drive waveform which comprises the drive sub-pulses SPi is processed to obtain control signals C1 and C2 which control the data driver 102 and the select driver 101 (see FIG. 6), respectively. This control of the data driver 102 and the select driver 101 is very similar to the known control. Usually, the select driver 101 selects during each frame period TF the lines of pixels 18 one by one, and the data driver 102 supplies the levels of the drive waveform to the selected line of pixels in parallel. The only difference is that the drive waveforms have another sequence of levels such that instead of the single continuous drive pulse DPk a sequence SSPk of drive sub-pulses SPi occurs.

The dashed line 103 indicates that this algorithm is performed by the controller 103 shown in FIG. 6. The controller 103 may comprise dedicated hardware to perform the steps mentioned. Alternatively, the controller 103 may comprise a suitably programmed microprocessor.

To conclude, the duration of the continuous drive pulse DPk (which refers to either the single drive pulse or the drive pulse of the sequence of different pulses) is roughly determined by scaling a standard stored drive waveform SDW with a factor dependent on the sensed temperature TI. Now, the required optimal duration of the continuous drive pulse DPk for the actual temperature TI is known. If possible, the frame period duration TF may be adapted to optimally fit the required duration. Usually, the frame rate is increased when the temperature increases until the minimum duration of the frame period MFPD is reached. If the duration RD of the continuous drive pulse DPk, which last an integer number of frame periods TF, is not sufficiently near to the required duration RD, the continuous drive pulse DPk is sub-divided in a sequence SSPk of drive sub-pulses SPi. The required number of drive sub-pulses SPi, and/or the duration of the drive sub-pulses SPi, and/or the duration of the separation period between the drive sub-pulses SPi to obtain a particular optical state which is in-between the optical states reachable with the continuous drive pulse DPk may be stored. These parameters of the drive sub-pulses SPi may be determined on beforehand. It has to be noted that the duration of each one of the drive sub-pulses SPi and separation periods are an integer times the actual frame period TF (which is the new frame period duration NFPD).

It should be noted that the above-mentioned embodiments illustrate rather than limit the invention, and that those skilled in the art will be able to design many alternative embodiments without departing from the scope of the appended claims. For example, although most embodiments in accordance with the invention are described with respect to an electrophoretic E-ink display, the invention is also suitable for electrophoretic displays in general and for bi-stable displays. Usually, an E-ink display comprises white and black particles which allows to obtain the optical states white, black and intermediate grey states. Although only two intermediate grey scales are shown, more intermediate grey scales are possible. If the particles have other colors than white and black, still, the intermediate states may be referred to as grey scales. The bi-stable display is defined as a display wherein the pixel (Pij) substantially maintains its grey level/brightness after the power/voltage to the pixel has been removed.

If is stated that a sub-divided pulse lasts a particular number of frame periods TF, it is meant that the energy of the sub-divided pulse is equal to the energy of a single pulse lasting this particular number of frame periods TF.

Although in these examples, pulse width modulated driving (PWM) schemes are used for illustration of this invention. It is also applicable to the driving schemes using a limited number of voltage levels combined with the PWM driving for further increasing the number of the grey levels. The electrodes may have top and bottom electrodes, honeycomb or other structures.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A drive circuit for a bi-stable display (100) having pixels (Pij) and comprising:
a driver (101, 102) for supplying drive waveforms (DWk) to the pixels (Pij) to obtain during an image update period (IUk) an update of an image presented by the pixels (Pij), and
a controller (103) for controlling the driver (101, 102) to supply during the image update period (IUk) to a particular one of the pixels (Pij) an associated one of the drive waveforms (DWk) to obtain a required optical transition, the associated one of the drive waveforms (DWk) comprising a drive pulse (DPi) being sub-divided in a sequence of a particular number of drive sub-pulses (SPk), wherein consecutive ones of the drive sub-pulses (SPk) of the sequence are separated by a non-zero separation period of time (SPT).

2. A drive circuit as claimed in claim 1, further comprising a temperature sensing circuit (108) for sensing a temperature of the bi-stable display (100), and wherein the controller (103) is arranged for controlling the particular number of said drive sub-pulses (SPk), and/or a duration of said drive sub-pulses (SPk), and/or a duration of the separation period (SPT) in response to the sensed temperature (TI).

3. A drive circuit as claimed in claim 1, wherein the drive circuit further comprises a memory (107) for storing the drive waveforms (DWk) required for all possible optical transitions of the pixels (Pij), at least one of waveforms (DWk) comprising the drive pulses (DPi) being sub-divided in the sequence of the particular number of drive sub-pulses (SPk).

4. A drive circuit as claimed in claim 2, wherein the controller (103) is arranged for controlling:
for the particular pixel (Pij), the driver (101, 102) to supply during the image update period (IUk) the drive waveform (DWk) comprising the drive pulse (DPk) being sub-divided in the particular number of the drive sub-pulses (SPk) separated by the separation period of time (SPT) as a series of sub-pulses (SSPk) if the sensed temperature (TI) is in a first range, and to supply a single continuous drive pulse (DPk) only, if the sensed temperature (TI) is in a second range below or above the first range, and
the particular number of said drive sub-pulses (SPk), and/or a duration of said drive sub-pulses (SPk), and/or a duration of the separation period (SPT) in response to the sensed temperature (TI) to obtain substantially the same optical transition at different temperatures.

5. A drive circuit as claimed in claim 1, wherein the controller (103) is arranged for controlling, for a particular pixel (Pij), the driver (101, 102) to supply during the image update period (IUk) the drive waveform (DWk) further comprising a shaking pulse (Sk) preceding the single continuous drive pulse (DPk) and/or preceding the series of sub-pulses (SSPk).

6. A drive circuit as claimed in claim 1, wherein the controller (103) is arranged for controlling, for a particular pixel (Pij), the driver (101, 102) to supply during the image update period (IUk) the drive waveform (DWk) further comprising a reset pulse (REk) preceding the single continuous drive pulse (DPk) and/or preceding the series of sub-pulses (SSPk).

7. A drive circuit as claimed in claim 6, wherein the controller (103) is arranged for controlling, for a particular pixel (Pij), the driver (101, 102) to supply, during an image update period (IUk) the reset pulse (Rek) being sub-divided in a particular number of reset sub-pulses (SPk) separated by a separation period of time (SPT) as a series of reset sub-pulses (SRPk) for resetting the particular pixel (Pij) to one of its extreme optical states.

8. A drive circuit as claimed in claim 7, wherein the controller (103) is arranged for controlling, for a particular pixel (Pij), the driver (101, 102) to supply during another image update period (IUk), the drive waveform (DWk) comprising a single continuous reset pulse (REk) instead of the series of sub-reset pulses (SRPk).

9. A drive circuit as claimed in claim 7, wherein the controller (103) is arranged for controlling the driver (101, 102) to supply during the image update period (IUk) a shaking pulse (S11) preceding the series of reset sub-pulses (SSPk).

10. A drive circuit as claimed in claim 8, wherein the controller (103) is arranged for controlling the driver (101, 102) to supply during the image update period (IUk) a shaking pulse (S11) preceding said single continuous reset pulse (REk).

11. A drive circuit as claimed in claim 7, wherein the controller (103) is arranged for controlling the driver (101, 102) to supply during the image update period (IUk) a shaking pulse (S12) occurring between said series of reset sub-pulses (SRPk) and the drive pulse (DPk).

12. A drive circuit as claimed in claim 8, wherein the controller (103) is arranged for controlling the driver (101, 102) to supply during the image update period (IUk) a shaking pulse (S12) occurring between said single continuous reset pulse (REk) and the drive pulse (DPk).

13. A drive circuit as claimed in claim 1, wherein the controller (103) is arranged for controlling the driver (101, 102) to supply a voltage level during the separation period of time (SPT) for substantially keeping unaltered an optical state of the particular one of the pixels (Pij).

14. A drive circuit as claimed in claim 13, wherein the controller (103) is arranged for controlling the driver (101, 102) to supply the voltage level during the separation period of time (SPT) being substantially equal to zero.

15. A drive circuit as claimed in claim 1, wherein the controller (103) is arranged for controlling the driver (101, 102) to supply during the separation period (SPT) a level opposite to the level of the one of the pulses (SPk) preceding the separation period (SPT).

16. A method of driving a bi-stable display (100) having pixels (Pij), the method comprises:
supplying (101, 102) drive waveforms (DWk) to the pixels (Pij) to obtain during an image update period (IUk) an update of an image presented by the pixels (Pij), and
controlling (103) the supplying (101, 102) to supply during the image update period (IUk) to a particular one of the pixels (Pij) an associated one of the drive waveforms (DWk) to obtain a required optical transition, the associated one of the drive waveforms (DWk) comprising a drive pulse (DPi) being sub-divided in a sequence of a particular number of drive sub-pulses (SPk), wherein consecutive ones of the drive sub-pulses (SPk) of the sequence are separated by a non-zero separation period of time (SPT), and wherein the associated one of the drive waveforms (DWk) comprises, during the separation period, a voltage level which substantially keeps an optical state of the particular one of the pixels (Pij) unaltered.

17. A display apparatus comprising a bi-stable display (100) and a drive circuit as claimed in claim 1.

18. A display apparatus as claimed in claim 17, wherein the bi-stable display (100) is an electrophoretic display (1).
